(19) United States
(12) Patent Application Publication
(10) Pub. No.: US 2002/0072125 A1
(43) Pub. Date: Jun. 13, 2002

(54) Method for rapidly determining the presence of malondialdehyde (MDA) in urine, in food and cosmetic products

(76) Inventors: Jean Morelle, Paris (FR); Eliane Lauzanne, Paris (FR); Jacqueline Rothfuss, Lauterbourg (FR)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 09/899,640

(22) Filed: Jul. 5, 2001

Related U.S. Application Data
(63) Continuation of application No. PCT/FR00/03089, filed on Nov. 7, 2000.

(30) Foreign Application Priority Data
Nov. 9, 2000 (FR) 99/14070

(51) Int. Cl. G01N 31/22

(52) U.S. Cl. 436/128; 422/56; 422/61; 427/2.13

(57) ABSTRACT

The invention concerns a method for rapidly determining the presence of malondialdehyde (MDA) in urine, food products and cosmetic products. It simply consists in placing a drop of urine, fat or a cosmetic product on an indicator paper impregnated with an aqueous solution comprising thiobarbituric acid and glycolic acid. A red chromogen is obtained resulting from the combination of malondialdehyde with thiobarbituric acid, ill the form of a characteristic ring.

The present application is a continuation of International Application No. PCT/FR00/03089. filed on Nov. 7, 2000, and the disclosure of which is incorporated by reference herein.

Many studies published world-wide over the last thirty years have shown that oxidative degradation of unsaturated fatty acids both in the cell membrane and in food constitutes a danger to health.

Oxidative degradation is known to result in many pathological conditions, and lipoperoxides are known to degrade, generating a variety of substances, forming new associations with proteins, in the manner of Schiff bases and lipopigments. Among the most reactive substances resulting from such degradation is malondialdehyde (MDA), a molecule containing 3 carbon atoms and two highly reactive aldehyde functions:

O═CH—CH₂—CH═O

Urinary MDA is known to be a response to free radical intervention; it is an in vivo lipidperoxidation indicator. It may result from a foodstuff comprising lipoperoxides, or it may result from a metabolic dysfunction, or from an endogenous or exogenous antioxidant deficiency.

Thus, the determination of MDA in urine is of considerable importance as it can demonstrate either the existence of an oxidative foodstuff that is a danger to health, which may result in biological perturbations expressed by various pathologies (cardiovascular, cataracts, cancer, etc. . . ), or it may be attributed to the pathologies themselves. Such a test could rapidly determine the existence of a metabolic perturbation connected either to a foodstuff or to a pathological condition.

Determining urinary MDA represents an important source of information for both the physician and the nutritionist. However, determining urinary MDA requires expensive analytical operations that can only be carried out in the laboratory.

This novel method, which is simple, rapid and reliable, can be used by anyone and can demonstrate the presence of MDA in both urine and in foodstuffs or in cosmetic preparations within two to three minutes. It simply consists in depositing a drop of urine or fatty substance on a reactive paper to demonstrate the presence of MDA.

It is also possible to use a series of different reference solutions of MDA to produce a scale of different concentrations, for example to determine urinary concentration.

This technique can be used to determine MDA in fats, such as food grade oils.

In this case, because of the small quantity of hydrophilic substance (MDA) in a large quantity of lipophilic oil, a little water is added to the oil and the mixture is stirred vigorously to obtain a temporary emulsion. A small drop of the emulsion is deposited on the reactive paper. The presence of MDA is demonstrated by a red ring at the centre of the drop of oil deposited on the paper.

It is also possible to allow the aqueous phase to decant then remove it and place a drop on the test paper. A characteristic pink to red ring will be obtained if MDA is present. If a certain amount of the oil has been entrained, a diffuse reddish disk is obtained.

This test can also be used to check that MDA is absent from different fatty substances and emulsions used in the cosmetics industry.

The invention is characterized in that it comprises a filter paper impregnated with a known reagent, thiobarbituric acid, in the presence of an organic acid the acidity of which is close to that of acetic acid, generally used in the anhydrous form to dissolve the thiobarbituric acid, at a pH of about 1.0 to 3.0, to avoid side reactions. Thiobarbituric acid reacts with MDA to produce a red chromogen.

Of the organic acids tested, glycolic acid produces a high sensitivity in the test, and produces a highly characteristic red ring in the region of the deposited drop, while the ring remains white when the urine is free of MDA. Other acids such as fumaric acid, citric acid or tartaric acid cannot produce sharp characteristic rings.

In accordance with the invention, filter paper strips are impregnated with a solution containing 0.5% by weight of thiobarbituric acid and 10% by weight of glycolic acid made up to 100 ml with distilled water. The strips are oven dried at about 80° C. and stored away from light and air.

Such a test is cheap and reliable; the strip with the drop of urine needs only to be exposed to a source of heat: an oven at 100° C., steam from boiling water or by bringing the paper close to an electric light bulb. Within three minutes, a pink to red ring will appear with an intensity that varies depending on the concentration of MDA in the test substance. When no MDA is present, the circle is whitish.

1. A method for rapidly demonstrating the presence of malondialdehyde in a sample capable of containing same comprising the steps of: contacting a reactive paper strip which includes thiobarbituric acid with at least one drop of said sample and exposing said reactive paper strip to heat, revealing a red chromogen as a result of the reaction of said thiobarbituric acid with malondialdehyde.

2. The method of claim 1 wherein said sample capable of containing malondialdehyde is selected from the group consisting of urine, foodstuffs or cosmetic products.

3. The method according to claim 2, wherein said sample is urine and the presence of urinary malondialdehyde is demonstrated by the formation of a red ring the intensity of which is dependent on its concentration.

4. The method according to claim 2, wherein said sample is a foodstuff or cosmetic products and the presence of malondialdehyde is demonstrated either by a pink or red ring or by a reddish disk.

5. A reactive paper useful for detecting or measuring malondialdehyde in a biological fluid comprising paper impregnated with a solution containing 0.1 to 1 g of thiobarbituric acid and 5 to 15 g of glycolic acid per 100 mL of distilled water, which is dried thereon.

6. The reactive paper according to claim 5, in which the biological fluid is urine.

7. The reactive paper according to claim 5, in which the impregnating solution contains 0.5 g of thiobarbituric acid and 10 g of glycolic acid per 100 mL of distilled water.

8. A kit for testing the presence of malondialdehyde in urine, foodstuffs or cosmetic products containing a reactive paper according to claim 5.

9. A kit for useful for detecting or measuring malondialdehyde in a sample comprising: at least one device according to claim 10 and a color scale of different concentrations of malondialdehyde.

10. A device for determining the presence of malondialdehyde in a sample capable of containing same comprising: a carrier and in combination with said carrier an amount of thiobarbituric acid which is sufficient to indicate, by the development of a color, the presence of malondialdehyde in a sample upon contact with a sample and upon heating of said device.

11. The device of claim 10 wherein said carrier is a liquid having a pH of 1 to 3.

12. The device of claim 11 wherein said carrier includes glycolic acid in an amount sufficient to provide-said carrier with a pH of 1 to 3.

13. The device of claim 10 wherein said carrier is a solid support impregnated with a solution comprising thiobarbituric acid, glycolic acid and water.

14. The device of claim 13 wherein said solid support is paper.

15. The device of claim 14 wherein said solution contains between 0.1 and 1 gram of said thiobarbituric acid and between 5 and 15 grams of said glycolic acid per 100 mL of water.

16. The device of claim 10 wherein the presence of malondialdehyde in a sample is determined colorimetrically.

17. A method of making a device for determining the presence of malondialdehyde in a sample comprising the steps of: providing a solid support; providing a solution containing thiobarbituric acid, said solution having a pH of between 1 and 3, combining a predetermined amount of said solution with said solid support, and drying both said solid support and said solution.

18. The method of claim 17 wherein said solution contains between 0.1 and 1 gram of thiobarbituric acid and between 5 and 15 grams of glycolic acid per 100 mL of water.

19. The method of claim 17, wherein said solid support is a filter paper strip which is impregnated with thiobarbituric acid dissolved in a solution of glycolic acid at a pH in the range 1 to 3, drying is conducted at a temperature of about 80° C.
